(19) United States
(12) Patent Application Publication
(10) Pub. No.: US 2025/0142409 A1
(43) Pub. Date: May 1, 2025

(54) DIGITAL TWIN DEVICE-BASED RAN-CORE CONVERGED MOBILE CORE NETWORK

(71) Applicant: ELECTRONICS AND TELECOMMUNICATIONS RESEARCH INSTITUTE, Daejeon (KR)

(72) Inventors: Sunjin KIM, Daejeon (KR); Hyochan BANG, Daejeon (KR); Myung Eun KIM, Daejeon (KR); Namseok KO, Daejeon (KR); Jong Seok LEE, Daejeon (KR)

(21) Appl. No.: 18/676,918

(22) Filed: May 29, 2024

(30) Foreign Application Priority Data
Oct. 30, 2023 (KR) 10-2023-0147108
Apr. 29, 2024 (KR) 10-2024-0056829
May 28, 2024 (KR) 10-2024-0068949

(51) Int. Cl. H04W 28/08; H04W 28/18

(52) U.S. Cl. CPC H04W 28/0846; H04W 28/18

(57) ABSTRACT

Various embodiments for a RAN-Core converged mobile core network based on digital twin devices are disclosed. In one embodiment, a method of operating a network function included in a core network of a mobile communication system and implemented as an electronic device comprises generating a digital twin for a User Equipment (UE); and providing a network service for the UE in cooperation with at least one other network function based on the generated digital twin.

### CROSS REFERENCE TO RELATED APPLICATION

The present application claims priority to Korean Patent Application No. 10-2023-0147108, filed on Oct. 30, 2023, No. 10-2024-0056829, filed on Apr. 29, 2024, and No. 10-2024-0068949, filed on May 28, 2024, the entire contents of which are incorporated herein for all purposes by this reference.

### BACKGROUND

### Technical Field

This disclosure relates to mobile network technology, and more particularly, some embodiments relate to a next-generation mobile communication system architecture which virtualizes a user equipment (User Equipment, hereinafter referred to as UE) as a digital twin, and integrates Radio Access Network (RAN) (e.g., Open RAN), Core Network (CN), and UE in the cloud (e.g., integrating at least some functions of each entity) to provide mobile services.

### Description of the Related Art

The mobile communication system architecture has an architecture where the UE, RAN, and CN are separated through their respective dedicated systems. The physical and logical separation architecture of the mobile communication system may have issues in terms of signal load, processing performance, and more.

For instance, the UE-RAN-CN functional separation architecture may cause control signal transmission delays due to multiple protocol conversions and redundant processing in the mobile network.

In another example, the UE-RAN-CN functional separation architecture may cause a bottleneck where signals are concentrated at a specific anchor point. In yet another example, the high degree of functional decomposition in the mobile CN may increase the Network Functions (NF) required to process the service requests of the UE, resulting in complex procedures and unnecessary signaling overhead.

Additionally, the mobile CN, with its stateful structure at the NF level, stores state data related to each control procedure in each NF, which can tightly bind control processing state data to specific NF instances. In this case, it may be difficult to dynamically scale in/out NF instances during runtime in response to varying input loads.

Moreover, a mobile network using a centralized mobility management mechanism may require significant signaling to maintain an operating PDU (Protocol Data Unit) session for TCP (Transmission Control Protocol) connections. In this case, if a large number of MTC (Machine Type Communications) devices such as unmanned aerial vehicles or autonomous vehicles attempt to access the network simultaneously, signaling overload may occur at the CN.

In yet another example, more severe end-to-end transmission delays may occur in terms of user experience considerations.

### SUMMARY

Therefore, there is a need to provide an improved mobile communication system architecture and related technologies.

One aspect of this disclosure provides a method of operating a network function included in a core network of a mobile communication system and implemented as an electronic device. The method may comprise generating a digital twin for a User Equipment (UE); and providing a network service for the UE by in interacting with at least one other network function based on the generated digital twin.

In some embodiments, the digital twin may include state information of the UE necessary for performing the network service.

In some embodiments, generating the digital twin may comprise generating the digital twin based on at least one of an input from a network operator, interaction with a Policy Control Function (PCF), and interaction with a Unified Data Management (UDM).

In some embodiments, the method may further comprise managing the generated digital twin, and providing the network service may comprise providing the network service based on the managed digital twin.

In some embodiments, managing the digital twin may comprise acquiring subscriber contract information from a UDM to establish a UE Context.

In some embodiments, managing the digital twin may comprise subscribing to an update notification service from a network function that manages information related to the UE among the at least one network function, so as to be notified of updated information when the information related to the UE is updated.

In some embodiments, the network function that manages information related to the UE may include at least one of PCF and UDM.

In some embodiments, the at least one other network function may include a united network anchor function, and the united network anchor function may control the setup of resources for the UE, including radio resources and core network resources, and perform data delivery between the UE and a data network based on the controlled setup of the resources.

In some embodiments, the network service may include at least one of initial registration of the UE, deregistration of the UE, delivery of data from the UE, delivery of data to the UE, PDU session establishment, and mobility control of the UE.

In some embodiments, the mobility control of the UE may include a handover between the united network anchor function and at least one other united network anchor function.

In some embodiments, the initial registration of the UE may include establishing a signaling-only PDU session between the UE and the united network anchor function.

In some embodiments, a control message according to the established signaling-only PDU session may be exchanged on an event basis between at least some of the UE, the network function, and the at least one other network function.

Another aspect of this disclosure provides a network device included in a mobile communication system. The network device may comprise a united control plane processing unit for controlling the setup of resources for a User Equipment (UE), including radio resources and core network resources; and a united user plane processing unit for performing data delivery between the UE and a data network based on the controlled setup of the resources.

In some embodiments, the network device may be connected to a distributed unit of a radio access network via an F1 interface and to at least one network function included in a core network via a Service Based Interface (SBI).

In some embodiments, the network device may comprise a module that controls the maintenance of UE mobility and session connectivity with at least one second network device included in the mobile communication system, and the second network device may comprise the united control plane processing unit and the united user plane processing unit.

In some embodiments, the network device may comprise a module that provides connection establishment and topology sharing with a united user plane processing unit included in at least one second network device, and provides an interface for connection with the at least one second network device.

In some embodiments, the united control plane processing unit may be connected to a distributed unit of a radio access network via an F1-c interface and processes a control plane of a central unit corresponding to the distributed unit.

In some embodiments, the united user plane processing unit may be connected to a distributed unit of a radio access network via an F1-u interface and performs a user plane function of the core network.

In some embodiments, the united user plane processing unit may manage policies including radio section policies and transport network policies, and perform Service Data Adaptation Protocol (SDAP) processing and data delivery based on the managed policies.

In some embodiments, the network device may be connected to at least one second network device included in the mobile communication system, and the second network device may comprise the united control plane processing unit and the united user plane processing unit.

In some embodiments, the network device and the at least one second network device may be connected in a full-mesh photonics network structure.

In some embodiments, the united user plane processing unit may control UE mobility and session connectivity maintenance between the network device and the at least one second network device.

Another aspect of this disclosure provides a communication device comprising a processor; one or more hardware-based transceivers; and a computer-readable storage medium containing instructions, wherein the instructions, when executed by the processor, cause the electronic device to perform at least one embodiment of the method of this disclosure.

Another aspect of this disclosure provides a non-transitory recording medium storing instructions readable by a processor of an electronic device, wherein the instructions cause the processor to perform embodiments of this disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, a network architecture and related technologies with excellent performance (e.g., in terms of signaling overhead, processing performance, transmission delay, scaling in/out, bottleneck prevention of, or procedural complexity) may be provided.

### BRIEF DESCRIPTION OF THE DRAWINGS

FIG. 1 is a diagram for explaining some embodiments of a mobile communication system.

FIG. 2 is a diagram for explaining some embodiments of a UNA-UP.

FIG. 3 is a diagram for explaining some embodiments of the network between UNAFs.

FIG. 4 is a diagram for explaining some embodiments of the signal path.

FIG. 5 is a diagram for explaining some embodiments of a UE transmitting and receiving information with the core network via a signaling-only PDU session (SOS).

FIG. 6 is a diagram for explaining some embodiments of generating a digital twin of a UE.

FIG. 7 illustrates a notation method for event-based control message exchange.

FIG. 8 is a diagram for explaining some embodiments of the initial registration procedure of a UE.

FIG. 9 illustrates information that may be included in a UE registration request transmitted to the UNAF.

FIG. 10 is a diagram for explaining some embodiments of the deregistration procedure of a UE.

FIG. 11 is a diagram for explaining some embodiments of a UE triggered Service Request procedure.

FIG. 12 is a diagram for explaining some embodiments of a Network triggered Service Request procedure.

FIG. 13 is a diagram for explaining some embodiments of PDU Session Establishment procedure.

FIG. 14 is a diagram for explaining some embodiments of the handover procedure between UNAFs.

FIG. 15 is a block diagram illustrating the internal configuration of an electronic device according to an embodiment of this disclosure.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

Various embodiments for mobile network technologies are disclosed.

In some embodiments, functional elements of UE-RAN-CN that provide mobile communication services may be virtualized in an edge cloud environment. Through this, duplicate functions may be integrated, and the existing network-centric centralized control structure may be reorganized into a user-centric decentralized distributed control structure to implement a sustainable and scalable next-generation mobile network system and operation method.

In some embodiments, an open RAN base station (O-CUCP (Centralized Unit Control Plane)) and core network functions may be integrated into a cloud-based open RAN base station (e.g., UNAF described below).

In some embodiments, a cloud-based open RAN base station may be extended to a service-based architecture (SBA) of a core network.

In some embodiments, UE-related service requests may be processed through this extended SBA.

In some embodiments, UE may be registered and deregistered through this extended SBA.

Some embodiments may reduce signal overhead by eliminating duplicate processing and protocol conversion caused by the architecture in which RAN and CN each constitute an anchor point, and support Stateless processing through digital twin UE and event-based message exchange structure to provide flexible scale in/out to service load, which can be used in the next-generation mobile CN considering NTN.

In some embodiments, an NF (e.g., VUEF described below) included in the CN of a mobile communication system and implemented by an electronic device may generate a digital twin for a UE, and interacts with at least one other NF (e.g., UNAF and other NFs described below) based on the generated digital twin to provide a network service for the UE.

In some embodiments, the digital twin may include state information of the UE necessary for performing the network service.

In some embodiments, the NF may generate the digital twin based on at least one of an input from a network operator, interaction with a Policy Control Function (PCF), and interaction with a Unified Data Management (UDM).

In some embodiments, the NF may manage the generated digital twin. In some embodiments, the NF may provide the network service based on the managed digital twin.

In some embodiments, the NF may acquire subscriber contract information from a UDM to establish a UE Context for managing the digital twin.

In some embodiments, the NF may subscribe to an update notification service from a network function that manages information related to the UE among the at least one NF, so as to be notified of updated information when the information related to the UE is updated.

In some embodiments, for managing the digital twin, the NF may subscribe to an update notification service from a NF (e.g., PCF and UDM) that manages information related to the UE among the at least one NF, so that when the information related to the UE is updated, the updated information can be notified.

In some embodiments, the at least one other NF may include a united network anchor function. In some embodiments, the united network anchor function may control the setup of resources for the UE and perform data delivery between the UE and a data network based on the controlled setup of the resources. In some embodiments, the resources for the UE may include radio resources and core network resources.

In some embodiments, the network service may be initial registration of the UE, deregistration of the UE, delivery of data from the UE, delivery of data to the UE, PDU session establishment, or mobility control of the UE (e.g., handover between UNAFs described below).

In some embodiments, the initial registration of the UE may include establishing a signaling-only PDU session between the UE and the united network anchor function.

In some embodiments, a control message according to the established signaling-only PDU session may be exchanged on an event basis between at least some of the UE, the network function, and the at least one other network function.

In some embodiments, a network device (e.g., UNAF described below) included in the mobile communication system may comprise a united control plane processing unit (e.g., UNA-CP described below) for controlling the setup of resources for a User Equipment (UE), including radio resources and core network resources; and a united user plane processing unit (e.g., UNA-UP described below) for performing data delivery between the UE and a data network based on the controlled setup of the resources.

In some embodiments, the network device may be connected to a distributed unit of a radio access network via an F1 interface and to at least one network function included in a core network via a Service Based Interface (SBI).

In some embodiments, the integrated control plane processor may be connected to a distributed unit of a radio access network via an F1-c interface and processes a control plane of a central unit corresponding to the distributed unit.

In some embodiments, the united user plane processing unit may be connected to a distributed unit of a radio access network via an F1-u interface and performs a user plane function of the core network.

In some embodiments, the united user plane processing unit may manage policies including radio section policies and transport network policies, and perform SDAP processing and data delivery based on the managed policies.

In some embodiments, the network device may be connected to at least one second network device (e.g., another UNAF described later).

In some embodiments, the network device and the at least one second network device may be connected in a full-mesh photonics network structure. In some embodiments, the united user plane processing unit may control UE mobility and session connectivity maintenance between the network device and the at least one second network device.

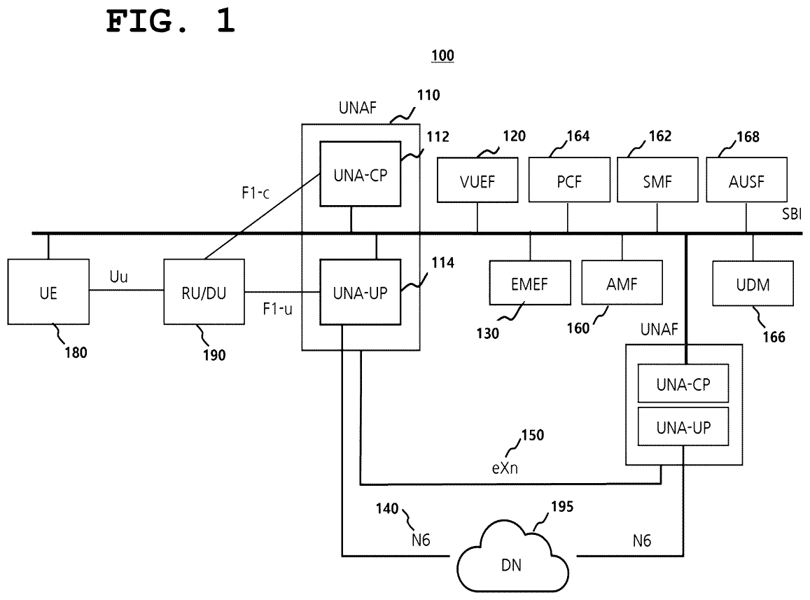

FIG. 1 is a diagram for explaining some embodiments of a mobile communication system.

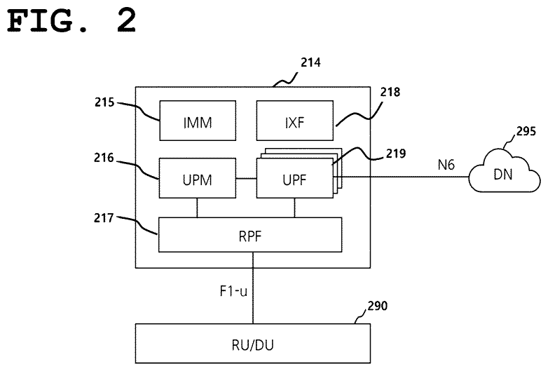

In some embodiments, as exemplified in FIG. 1, the communication system (100) may include a UNAF (United Network Anchor Function, 110). In some embodiments, the UNAF (110) may constitute a RAN-Core converged mobile core network by including a Centralized Unit (CU) of the RAN and a User Plane Function (UPF) of the CN. In some embodiments, the UNAF (110) may unify functions that are decoupled or duplicated in the wired and wireless sections of the communication system (100) on the cloud to integrally control wired and wireless resources. In some embodiments, as illustrated in FIG. 1, the UNAF (110) may be connected to other UNAFs via an eXn (evolved Xn, 150) interface. The eXn (150) will be described later with reference to FIG. 2, etc.

In some embodiments, as illustrated in FIG. 1, the communication system (100) may include a VUEF (Virtualized User Equipment Function, 120). In some embodiments, the VUEF (120) may digitally twin the state information of a User Equipment (UE) (180) to constitute a digital twin device-based mobile CN. In some embodiments, the VUEF (120) may handle processing of network service requests from (or on behalf of) the UE (180) and control information synchronization with the UE (180).

In some embodiments, most of the UE (180) information required in the CN is synchronized with the digitally twinned VUEF (120), reducing the amount of information transmitted and received over the wireless section, and eliminating redundant information delivery.

In some embodiments, as exemplified in FIG. 1, the communication system (100) may include an EMEF (Evolved Message Exchange Function, 130). In some embodiments, the EMEF (130) may perform message delivery between the UE (180) and Network Functions (NFs) of the CN and/or message delivery between NFs of the CN. In some embodiments, the EMEF (130) may be an interface function that exchanges messages in an event-driven manner.

In some embodiments, as illustrated in FIG. 1, the communication system (100) may include the UE (180), a RU (Radio Unit)/DU (Distributed Unit) (190) of the RAN, NFs of the CN, and a DN (Data Network, 195). For example, the communication system (100) may include at least some of an AMF (Access and Mobility Management Function, 160), SMF (Session Management Function, 162), PCF (Policy Control Function, 164), UDM (Unified Data Management, 166), and AUSF (Authentication Server Function, 168) as NFs of the CN.

In some embodiments, the UNAF (110) may be located in an edge cloud, and the VUEF (120), EMEF (130), and other NFs may be located in a central cloud.

In some embodiments, as illustrated in FIG. 1, the UNAF (110) may include a UNA-CP (Control Plane) (112) and a UNA-UP (User Plane) (114).

In some embodiments, the UNA-CP (112) may integrally control resource setup for the UE (180). For example, the resources to be set up may include radio resources and CN resources.

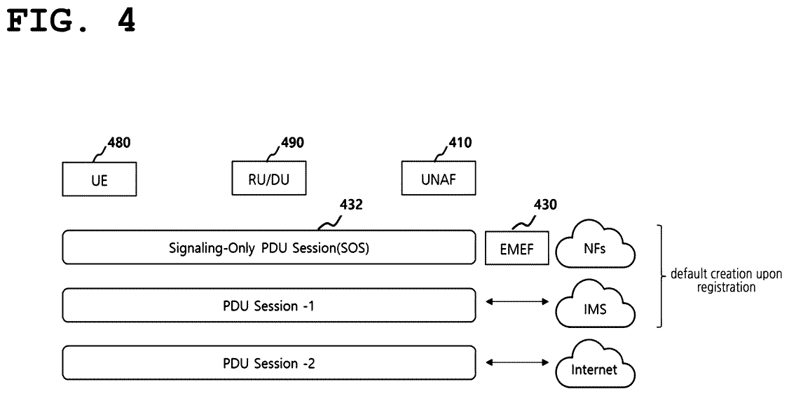

In some embodiments, the UNA-CP (112) may provide control signaling related to the UE (180) through the EMEF (130). For example, if the UE (180) selects a direct interaction method via the SBI (Service Based Interface), the UNA-CP (112) may provide control signaling through the EMEF (130). The control signaling through the EMEF (130) will be described later with reference to FIG. 4. In other embodiments, the UNA-CP (112) may provide control signaling related to the UE (180) through the AMF (160). For example, if the UE (180) selects an indirect interaction method via the AMF (160), the UNA-CP (112) may provide control signaling via existing methods (e.g., NAS).

In some embodiments, the UNA-UP (114) may deliver user data to the DN (195).

FIG. 2 is a diagram for explaining some embodiments of a UNA-UP.

In some embodiments, the UNA-UP (214), RU/DU (290), and DN (295) illustrated in FIG. 2 may correspond to the UNA-UP (114), RU/DU (190), and DN (195) exemplified in FIG. 1.

In some embodiments, as illustrated in FIG. 2, the UNA-UP (214) may include an IMM (eXn based Inter Mobility Management, 215), UPM (Unified Policy Management, 216), RPF (Resource Provisioning Function, 217), IXF (eXn based Inter exchange Function, 218), and UPF (219).

In some embodiments, the UPM (216) may perform mapping for radio section policies and transport network policies such as QoS mapping, and may perform policy control at the user packet flow level through the PCF.

In some embodiments, the RPF (217) may perform Service Data Adaptation Protocol (SDAP) processing that maps a QFI (QoS Flow ID) with a DRB (Data Radio Bearer) using an integrated policy (e.g., QoS Rule) defined in the UPM (216). In some embodiments, as illustrated in FIG. 2, the RPF (217) may be connected to the RU/DU (290) through an F1-u interface.

In some embodiments, the UPF (219) may perform mapping between QFI (QoS Flow ID) of CN and QoS of transport network, using the integrated policy (e.g., QoS Rule) defined in the UPM (122). In some embodiments, as illustrated in FIG. 2, the UPF (219) may be connected to the DN (295) via the N6 interface.

In some embodiments, the IMM (215) may control UE mobility and session connectivity maintenance between UNAFs (Inter-UNAF).

In some embodiments, the IXF (218) may provide connection establishment between UNA-UPS, topology sharing, and eXn interfaces.

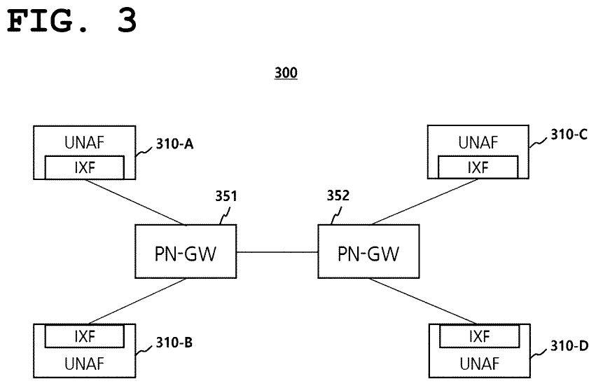

FIG. 3 is a diagram for explaining some embodiments of the network between UNAFs.

In some embodiments, as illustrated in FIG. 3, in the network (300) between UNAFs, multiple UNAFs (310-A, 310-B, 310-C, 310-D) may be connected in a full-mesh form of a photonics network structure through PN-GWs (Photonics Network-Gateways) (351, 352).

In some embodiments, the two UNAFs illustrated in FIG. 1 may correspond to two UNAFs among the multiple UNAFs (310-A, 310-B, 310-C, 310-D) illustrated in FIG. 3.

FIG. 4 is a diagram for explaining some embodiments of the signal path.

In some embodiments, as illustrated in FIG. 4, a signal path for UE evolved SBA extension may be configured.

In some embodiments, the UE (480), RU/DU (490), UNAF (410), EMEF (430), and NF illustrated in FIG. 4 may correspond to the UE (180), RU/DU (190), UNAF (110), EMEF (130), and NFs (120, 160, 162, etc.) illustrated in FIG. 1.

In some embodiments, as illustrated in FIG. 4, a signaling-only PDU session SOS (Signal Only Session, 432), a PDU session for IMS (IP Multimedia Subsystem) data transmission (PDU Session −1), and a PDU session for internet data transmission (PDU Session −2) may be used. In some embodiments, the UE (480) and CN may exchange SBI-based control signal information through SOS (432). In some embodiments, the SOS (432) may be created by setting the URI (Uniform Resource Identifier) of the EMEF (430), which provides the relay function for message delivery, as the APN (Access Point Name), and it may be performed in the same manner as other PDU session establishment procedures. For example, the EMEF (430) may be deployed at the entrance of a PLMN (Public Land Mobile Network) cloud where NEs of the CN are deployed.

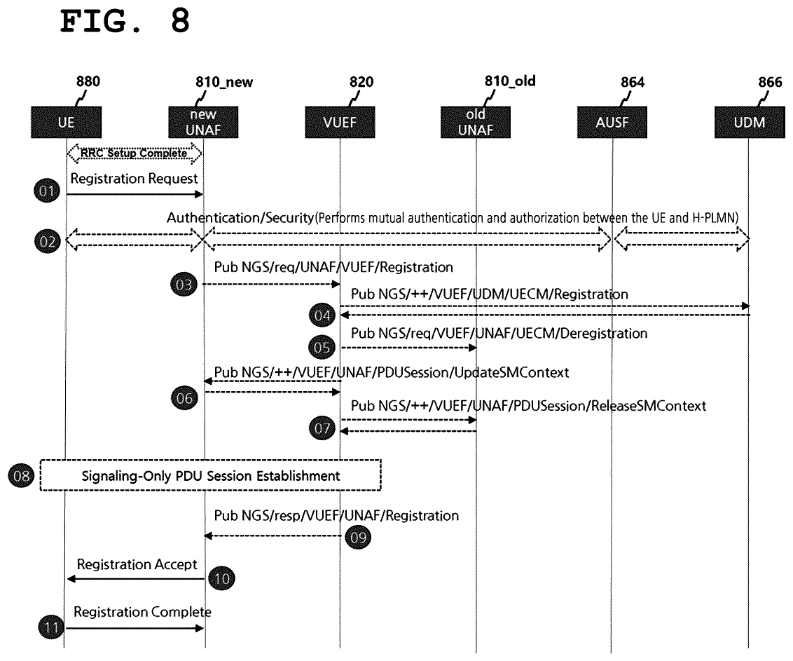

In some embodiments, the signaling-dedicated PDU session SOS (Signal Only Session, 432) and the PDU session (PDU Session −1) for IMS data transmission may be created and activated through an initial registration procedure of the UE (480). The initial registration procedure will be described later with reference to FIG. 8.

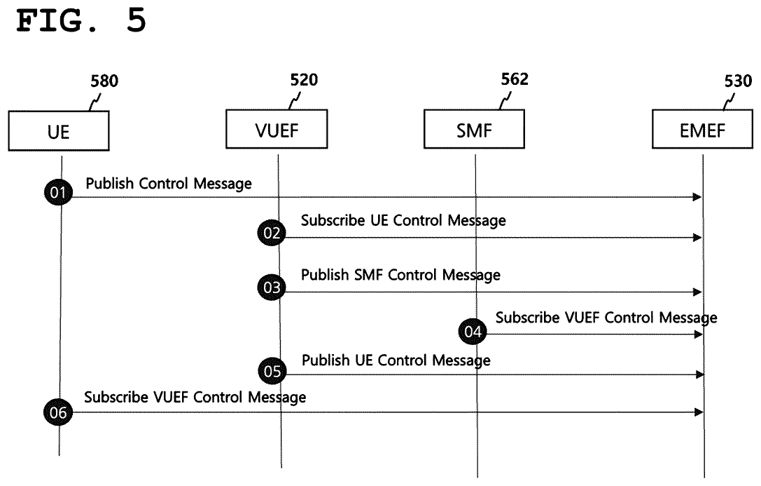

FIG. 5 is a diagram for explaining some embodiments of a UE transmitting and receiving information with the core network via a signaling-only PDU session (SOS).

In some embodiments, the UE (580), VUEF (520), SMF (562), and EMEF (530) illustrated in FIG. 5 may correspond to the UE (180), VUEF (122), SMF (162), and EMEF (130) illustrated in FIG. 1.

In some embodiments, the UE (580) may publish a control message (hereinafter, message A) to the EMEF (530) to deliver the control message (message A) to the VUEF (520) (01).

In some embodiments, the EMEF (530) may deliver the control message (message A) to the VUEF (520) that has subscribed to the message topic for the UE (580) (02).

In some embodiments, the VUEF (520) may publish a control message (hereinafter, message B) to the EMEF (530) to deliver the control message to another NF. For example, as illustrated in FIG. 5, the VUEF (520) may publish to the EMEF (530) to deliver the control message (message B) to the SMF (562) (03), and the EMEF (530) may deliver the control message (message B) to the SMF (562) that has subscribed to the message topic for the VUEF (04).

In some embodiments, the VUEF (520) may publish a control response message (hereinafter, message C) to the EMEF (530) to deliver the control response message to the UE (580) (05).

In some embodiments, the EMEF (530) may deliver the control response message (message C) to the UE (580) that has subscribed to the VUEF message topic (06).

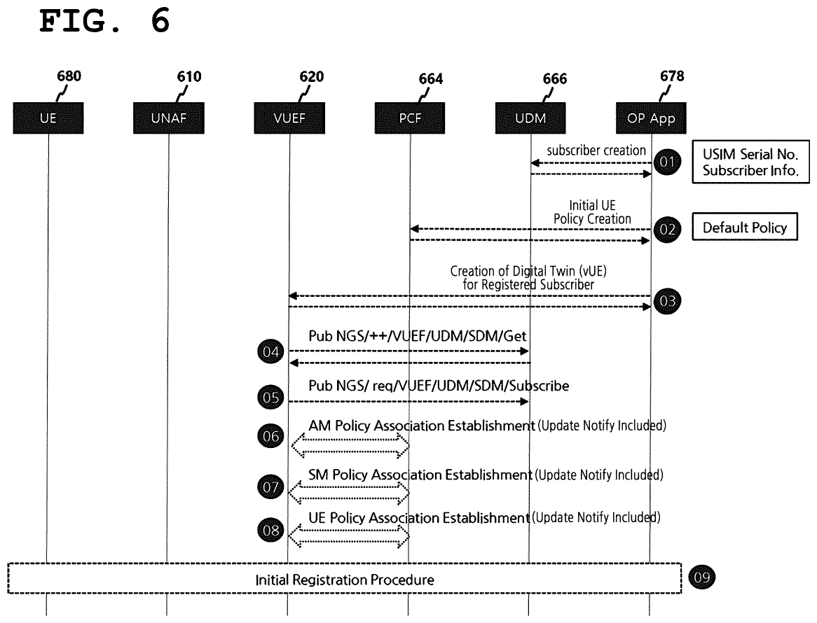

FIG. 6 is a diagram for explaining some embodiments of generating a digital twin (VUE (virtual UE) of a UE.

For example, during the process of a subscriber registering a new device with a communication service provider (PLMN), a digital twin (VUE) of the subscriber's device (e.g., UE) may be generated in the service provider's cloud.

In some embodiments, the UE (680), UNAF (610), VUEF (620), PCF (664), and UDM (666) illustrated in FIG. 6 may correspond to the UE (180), UNAF (110), VUEF (120), PCF (164), and UDM (166) illustrated in FIG. 1.

In some embodiments, the operator may provide a USIM (Universal Subscriber Identify Module) serial number, subscriber information, etc. to the UDM (666) through an OP App (Operator Application) (678) or the like, to cause the UDM (666) to perform subscriber creation (01).

In some embodiments, the operator may cause the PCF (664) to create an initial policy (Default Policy) through the OP App (678) or the like, according to the service and rate plan selected by the subscriber (02).

In some embodiments, the operator may cause the VUEF (620) to generate a digital twin (vUE) of the registered subscriber through the OP App (678) or the like (03).

In some embodiments, the VUEF (620) may acquire subscriber contract information from the UDM (666) to establish a UE Context (04).

In some embodiments, the VUEF (620) may subscribe to a subscriber contract information update notification service from the UDM (666) (05).

In some embodiments, the VUEF (620) may establish an AM (Access Management) Policy Association with the PCF (664) for access and mobility management policy control (06). In some embodiments, through the established AM Policy Association, the VUEF (620) may acquire the necessary AM Policy from the PCF (664), or receive notification of changes if the policy is changed.

In some embodiments, the VUEF (620) may establish an SM (Session Management) Policy Association with the PCF for session management policy control (07). In some embodiments, through the established SM Policy Association, the VUEF (620) may acquire the necessary SM Policy from the PCF (664), or receive notification of changes if the policy is changed.

In some embodiments, if a UE Policy such as URSP (UE Route Selection Policy) is provided, the VUEF (620) may establish a UE Policy Association with the PCF (664), and the PCF (664) may implement UE configuration changes for UE Policy update (08). In some embodiments, through the established UE Policy Association, the VUEF (620) may acquire the necessary UE Policy, or receive notification of changes if the policy is changed.

In some embodiments, an initial registration procedure may be performed (09). For example, when the UE is powered on, the initial registration procedure may be performed.

In some embodiments, before the initial registration procedure is performed, at least some of blocks 06, 07, and 08 may be omitted.

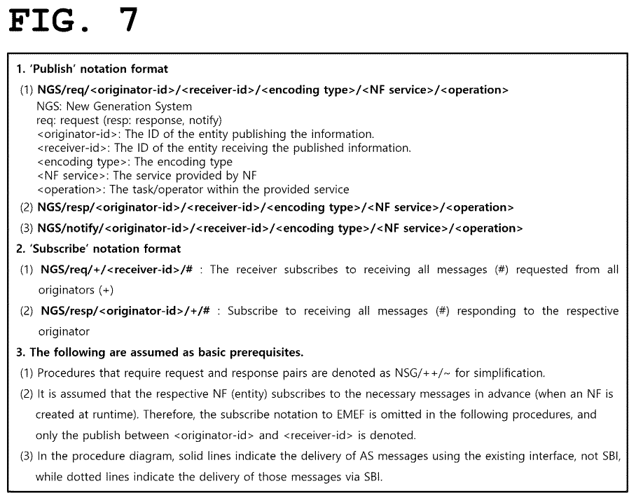

FIG. 7 illustrates a notation method for event-based control message exchange.

For example, the event-based control message exchange notation method of FIG. 7 may be used to explain the procedures (e.g., the embodiments related to FIGS. 6, 8 to 14) of the present disclosure.

FIG. 8 is a diagram for explaining some embodiments of the initial registration procedure of a UE.

For example, when the UE is powered ON, the initial registration procedure may be performed. For example, as illustrated in FIG. 8, after the RRC (Radio Resource Control) connection setup between the UE and the base station is completed, the initial registration procedure may be performed.

In some embodiments, the UE (880), UNAF (810_new, 810_old), VUEF (820), AUSF (864), and UDM (866) illustrated in FIG. 8 may correspond to the UE (180), UNAF (110, another UNAF without a label), VUEF (120), AUSF (164), and UDM (166) illustrated in FIG. 1.

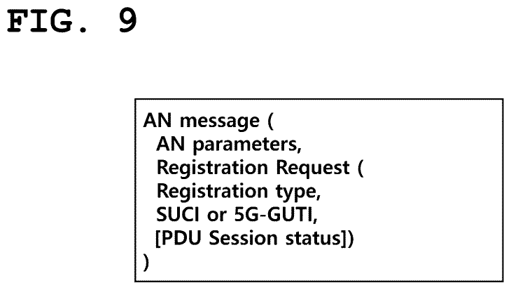

In some embodiments, the UE (880) may request UE registration to the UNAF (810_new) (01). For example, if the UE (880) has a temporary UE identifier NG-GUTI (New Generation-Global Unique Temporary Identifier), the UE (880) may transmit the NG-GUTI to the new UNAF (810_new) (01). In another example (e.g., when there is no NG-GUTI), the UE (580) may transmit information including an SUCI (Subscription Concealed Identifier) to the new UNAF (810_new). FIG. 9 illustrates information that may be included in a UE registration request transmitted to the UNAF (810_new).

In some embodiments, mutual authentication and authorization between the UE (880) and the H-PLMN (Home-PLMN) may be performed (02).

In some embodiments, the UNAF (810_new) may request UE registration to the VUEF (820) (03).

In some embodiments, when the UE (880) is connected to the new UNAF (810_new), the VUEF (820) may notify the UDM (866) of the current serving UNAF (810_new) of the UE (880) and store it (04).

In some embodiments, as illustrated in FIG. 8, if there is a previously registered UNAF (810_old) for the UE (880), the VUEF (820) may request deregistration from the previous UNAF (810_old) (05).

In some embodiments, the VUEF (820) may check with the new UNAF (810_new) for existing PDU session information and request context updates related to the PDU session, and receive the results in response (06).

In some embodiments, the VUEF (820) may request the previous UNAF (810_old) to release the PDU session-related context and receive the results in response (07).

In some embodiments, a signaling-only PDU session may be established between the UE (880) and the UNAF (810_new) (08). For example, if block 07 is successfully completed, a signaling-only PDU session may be established between the UE (880) and the UNAF (810_new).

In some embodiments, the VUEF (820) may transmit a UE initial registration acceptance message including signaling-only PDU information to the UNAF (810_new) (09).

In some embodiments, the UNAF (810_new) may transmit a registration acceptance message including NG-GUTI information to the UE (880) (10).

In some embodiments, the UNAF (810_new) may receive a registration complete message from the UE (580) to confirm that the new NG-GUTI information has been normally assigned (11).

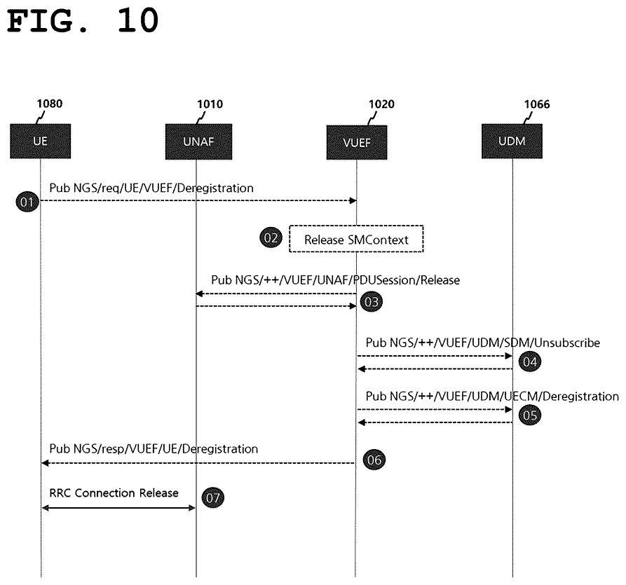

FIG. 10 is a diagram for explaining some embodiments of the deregistration procedure of a UE. For example, when the UE is powered OFF, the deregistration procedure may be performed.

In some embodiments, the UE (1080), UNAF (1010), VUEF (1020), and UDM (1066) illustrated in FIG. 10 may correspond to the UE (180), UNAF (110), VUEF (120), and UDM (166) illustrated in FIG. 1, respectively.

In some embodiments, the UE (1080) may request deregistration to the VUEF (720), which is responsible for its digital twin (vUE), through a signaling-only PDU session (01).

In some embodiments, the VUEF (1020) may release the context (SM Context) for the PDU session related to the UE (1080) that it holds (02).

In some embodiments, the VUEF (1020) may request the UNAF (1010) to release the PDU session and receive the result in response (03).

In some embodiments, the VUEF (1020) may request the UDM (1066) to release the change notification for the SM (Session Management) subscription data registered in the UDM (1066) and receive the result in response (04).

In some embodiments, the VUEF (1020) may request deregistration related to the corresponding PDU session to the UDM (1066) and receive the result in response (05).

In some embodiments, the VUEF (1020) may approve the UE deregistration to the UE (1080) (06).

In some embodiments, if there is an N2 signaling connection with the UE (1080), the UNAF (1010) may release the N2 signaling connection (07).

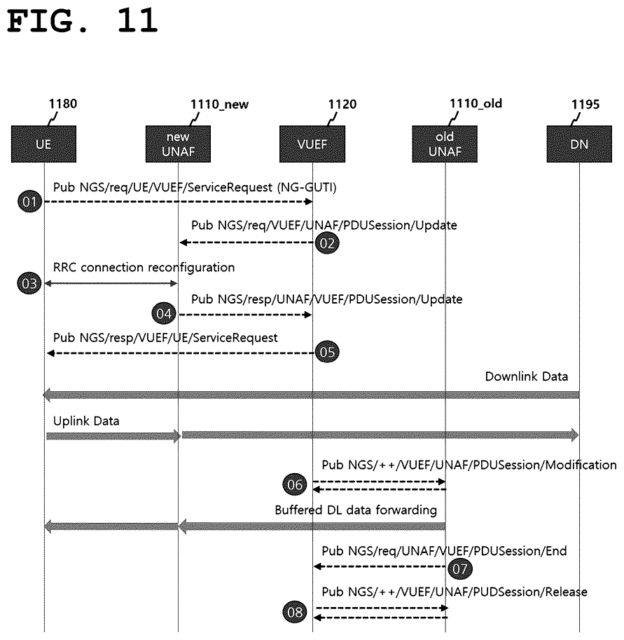

FIG. 11 is a diagram for explaining some embodiments of a UE triggered Service Request procedure.

For example, FIG. 11 may illustrate an embodiment in which the UE (1180) activates a user plane connection for a previously established PDU session (e.g., a signaling-only session).

In some embodiments, the UE (1180), UNAF (1110_new, 1110_old), VUEF (1120), and DN (1195) illustrated in FIG. 11 may correspond to the UE (180), UNAF (110, another UNAF without a label), VUEF (120), and DN (195) illustrated in FIG. 1, respectively.

In some embodiments, the UE (1180) may request a service by transmitting a request including an NG-GUTI to the VUEF (1120) (01).

In some embodiments, the VUEF (1120) may check with the new UNAF (1110_new) for existing PDU session information. If available, it may update the PDU session information, and if not, it may request the establishment of a new PDU session (02).

In some embodiments, the UNAF (1110_new) may perform RRC connection reconfiguration with the UE (1180) according to the Qos information for all QoS flows of the PDU session and Data Radio Bearer with UP connection activated (03).

In some embodiments, the UNAF (1110_new) may send a response of the result of the PDU session information (QFI, QoS profile, etc.) update and creation to the VUEF (1120) (04).

In some embodiments, the VUEF (1120) may reply to the UE (1180) with the service request result (05).

In some embodiments, after block 05, the UE (1180) may perform data transmission and reception with the DN (1195).

In some embodiments, the VUEF (1120) may notify the previous UNAF (1110_old) that the existing PDU session has been changed, and instruct the previous UNAF (1110_old) to deliver the buffered downlink (DL) data to the new UNAF (1110_new) (06).

In some embodiments, after block 06, the previous UNAF (1110_old) may deliver the buffered DL data to the UE (1180) through the new UNAF (1110_new).

In some embodiments, the previous UNAF (1110_old) may notify the VUEF (1120) of the termination of the existing PDU session (07).

In some embodiments, the VUEF (1120) may request the previous UNAF (1110_old) to release the resources associated with the existing PDU session and receive the result in response (08).

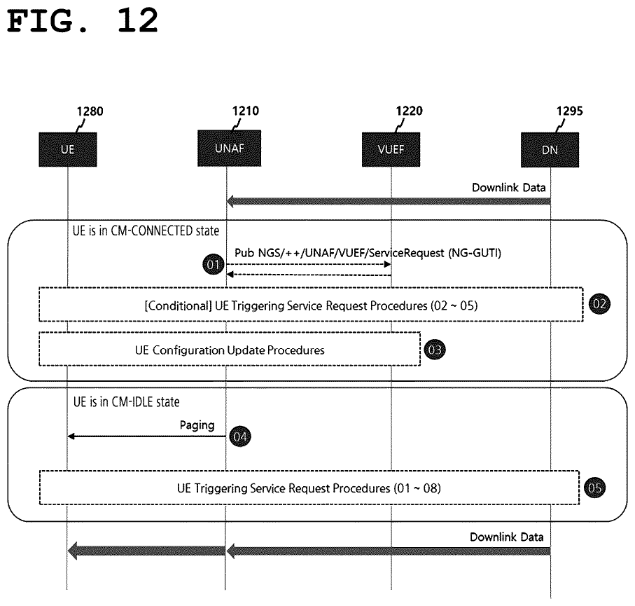

FIG. 12 is a diagram for explaining some embodiments of a Network triggered Service Request procedure.

For example, FIG. 12 may illustrate an embodiment where the network activates the user plane connection for a previously established PDU session when the UE (1280) is in the CM (Connection Management)-CONNECTED state and an embodiment where the network activates the user plane connection for a previously established PDU session when the UE (1280) is in the CM-IDLE state.

In some embodiments, the UE (1280), UNAF (1210), VUEF (1220), and DN (1295) illustrated in FIG. 12 may correspond to the UE (180), UNAF (110), VUEF (120), and DN (195) illustrated in FIG. 1.

In some embodiments, the UNAF (1210) may receive DL data destined for the UE (1280) from the DN (1295). For example, the UNAF (1210) may buffer the received data.

In some embodiments, when the UNAF (1210) receives DL data destined for the UE (1280) from the DN (1295), if the UE (1280) is in the CM-CONNECTED state, block 01 may be performed, and if the UE (1280) is in the CM-IDLE state, block 04 may be performed.

In some embodiments, in block 01, the UNAF (1210) may report to the VUEF (1220) about the buffered DL data received from the DN (1295). For example, in block 01, the UNAF (1210) may request the VUEF (1220) to provide the service of delivering the state (e.g., buffering of received data) to the UE (1280) and receive the result in response.

In some embodiments, after performing block 01, block 02 may be selectively performed if necessary. In some embodiments, block 02 of FIG. 12 may include blocks 02 to 05 of FIG. 11.

In some embodiments, block 03 may be performed after performing block 01 and block 02 (if selectively performed). For example, if the PDU session-related context is changed, the VUEF (1220) may initiate a UE configuration update procedure to update the relevant information.

In some embodiments, in block 04, the UNAF (1210) may page the UE (1280).

In some embodiments, after paging, the VUEF (1220) may perform block 05. In some embodiments, block 05 may include blocks 01 to 08 of FIG. 11.

In some embodiments, after block 05, the UNAF (1210) may deliver the DL data received from the DN (1295) to the UE (1280).

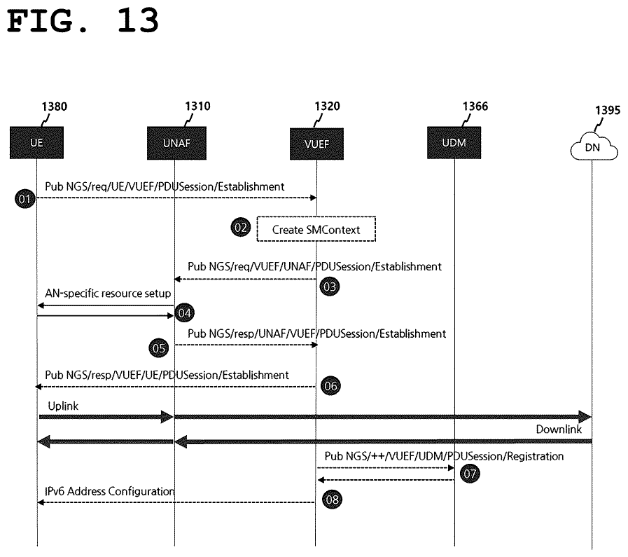

FIG. 13 is a diagram for explaining some embodiments of PDU Session Establishment procedure.

In some embodiments, the UE (1380), UNAF (1310), VUEF (1320), UDM (1366), and DN (1395) illustrated in FIG. 13 may correspond to the UE (180), UNAF (110), VUEF (120), UDM (166), and DN (195) illustrated in FIG. 1, respectively.

In some embodiments, the UE (1380) may request the VUEF (1320) to establish a PDU session (01). In some embodiments, the message for requesting PDU session establishment may include S-NSSAI(s), UE Requested DNN, PDU Session ID, Request type, Old PDU Session ID, N1 SM container (PDU Session Establishment Request, [Port Management Information Container]).

In some embodiments, upon receiving the request for PDU session establishment, the VUEF (1320) may create a session-related context (02). In some embodiments, the session-related context may include SUPI, selected DNN, UE requested DNN, S-NSSAI(s), PDU Session ID, AMF ID, Request Type, [PCF ID, Same PCF Selection Indication], Priority Access, [Small Data Rate Control Status], N1 SM container (PDU Session Establishment Request), User location information, Access Type, RAT Type, PEI, GPSI, UE presence in LADN service area, Subscription For PDU Session Status Notification, DNN Selection Mode, Trace Requirements, Control Plane CIoT 5GS Optimization indication, Control Plane Only indicator, Satellite backhaul category, GEO Satellite ID, [PVS FQDN(s) and/or PVS IP address(es), Onboarding Indication], Disaster Roaming service indication.

In some embodiments, the VUEF (1320) may request the UNAF (1310) to establish a PDU session (i.e., session establishment with UNA-UP) (03).

In some embodiments, the UNAF (1310) may setup an AN-specific resource with the UE (1380) (04).

In some embodiments, the UNAF (1310) may respond to the VUEF (1320) with the result of the PDU session establishment (05).

In some embodiments, the VUEF (1320) may reply to the UE (1380) with the completion of PDU session establishment (06).

In some embodiments, after block 06, the UE (1380) may transmit and receive data with the DN (1395).

In some embodiments, the VUEF (1320) may register the PDU session information with the UDM (1366) and receive the result in response (07).

In some embodiments, the VUEF (1320) may allocate an IPv6 address to the UE (1380) (08).

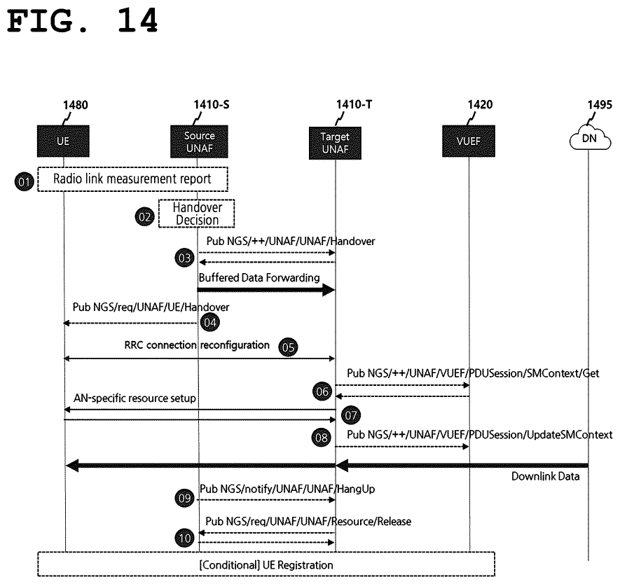

FIG. 14 is a diagram for explaining some embodiments of the handover procedure between UNAFs.

In some embodiments, the UE (1480), UNAF (1410_S, 1410_T), VUEF (1420), and DN (1495) illustrated in FIG. 14 may correspond to the UE (180), UNAF (110, another UNAF without a label), VUEF (120), and DN (195) illustrated in FIG. 1.

In some embodiments, the UE (1480) may report the results of its radio link state measurement to the source UNAF (1410-S) (01).

In some embodiments, the source UNAF (1410-S) may determine whether to perform a handover based on the radio link state measurement results reported in block 01 (02). For example, the source UNAF (1410-S) may decide to perform the handover, as illustrated in FIG. 13.

In some embodiments, the source UNAF (1410-S) may request the handover to the target UNAF (1410-T) and receive the result in response (03). In some embodiments, after block 03, the source UNAF (1410-S) may initiate the transmission of buffered user packets to the target UNAF (1410-T).

In some embodiments, the source UNAF (1410-S) may instruct the UE (1480) to perform a Uu handover (04).

In some embodiments, the UE (1480) may perform RRC connection reconfiguration with the target UNAF (1410-T) (05).

In some embodiments, the target UNAF (1410-T) may request an existing PDU session-related context from the VUEF (1420) and receive the result in response (06).

In some embodiments, the target UNAF (1410-T) may setup AN (Access Network)-specific resources with the UE (1480) (07).

In some embodiments, the target UNAF (1410-T) may request the VUEF (1420) to update the PDU session-related context (08).

In some embodiments, after block 08, the target UNAF (1410-T) may deliver the DL data received from the DN (1495) to the UE (1480).

In some embodiments, the source UNAF (1410-S) may notify the target UNAF (1410-T) of the handover completion (09).

In some embodiments, the target UNAF (1410-T) may request the source UNAF (1410-S) to release the existing resources and receive the result in response (10).

In some embodiments, after performing block 10, a UE registration procedure may be selectively performed if necessary.

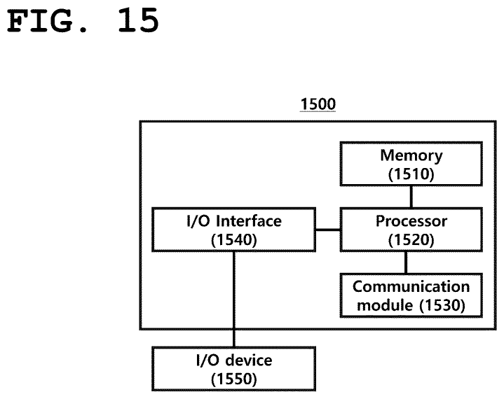

FIG. 15 is a block diagram illustrating the internal configuration of an electronic device (e.g., a device performing UNAF, VUEF, EMEF, and/or other network functions) according to an embodiment of this disclosure.

As illustrated in FIG. 15, the electronic device (1500) may include a memory (1510), a processor (1520), a communication module (1530), and an input/output interface (1540). The memory (1510) may be a computer-readable recording medium and may include a RAM (random access memory), a ROM (read only memory), and a non-volatile mass storage device such as a disk drive. Here, the ROM and the non-volatile mass storage devices may be included as separate permanent storage devices apart from the memory (1510). Additionally, the memory (1510) may store an operating system and at least one program code (e.g., a computer program stored on the recording medium included in the electronic device (1500) to control the electronic device (1500) to perform methods according to embodiments of the present disclosure). These software components may be loaded from a computer-readable recording medium separate from the memory (1510). This separate computer-readable recording medium may include floppy drives, disks, tapes, DVD/CD-ROM drives, memory cards, and other computer-readable recording media. In other embodiments, the software components may be loaded into the memory (1510) via the communication module (1530) instead of a computer-readable recording medium.

The processor (1520) may be configured to process instructions of a computer program by performing basic arithmetic, logic, and input/output operations. The instructions may be provided to the processor (1520) by the memory (1510) or the communication module (1530). For example, the processor (1520) may be configured to execute the instructions received according to the program code loaded into the memory (1510). As a more specific example, the processor (1520) may sequentially execute the instructions according to the code of the computer program loaded into the memory (1510) to perform the methods according to the embodiments of the present disclosure.

The communication module (1530) may provide functions for communicating with other physical devices over an actual computer network. For example, while the processor (1520) of the electronic device (1500) performs part of the process of the present embodiment, another physical device in the network (e.g., another computing system not shown) can perform the remaining process, and the processing results may be exchanged via the computer network and the communication module (1530) to perform the embodiments of the present disclosure.

The input/output interface (1540) may serve as a means for interfacing with input/output devices (1550). For example, input devices in the input/output devices (1550) may include devices such as a keyboard or a mouse, and output devices may include devices such as a display or speakers. In FIG. 15, the input/output devices (1550) are represented as separate devices from the electronic device (1500), but in some embodiments, the electronic device (1500) may be implemented to include the input/output devices (1550).

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

1. A method of operating a network function included in a core network of a mobile communication system and implemented as an electronic device, comprising:
generating a digital twin for a User Equipment (UE); and
providing a network service for the UE by in interacting with at least one other network function based on the generated digital twin.

2. The method of claim 1, wherein the digital twin includes state information of the UE necessary for performing the network service.

3. The method of claim 1, wherein generating the digital twin comprises generating the digital twin based on at least one of an input from a network operator, interaction with a Policy Control Function (PCF), and interaction with a Unified Data Management (UDM).

4. The method of claim 1, further comprising managing the generated digital twin,
wherein providing the network service comprises providing the network service based on the managed digital twin.

5. The method of claim 4, wherein managing the digital twin comprises acquiring subscriber contract information from a UDM to establish a UE Context.

6. The method of claim 4, wherein managing the digital twin comprises subscribing to an update notification service from a network function that manages information related to the UE among the at least one network function, so as to be notified of updated information when the information related to the UE is updated.

7. The method of claim 6, wherein the network function that manages information related to the UE includes at least one of PCF and UDM.

8. The method of claim 1, wherein the at least one other network function includes a united network anchor function,
wherein the united network anchor function controls the setup of resources for the UE, including radio resources and core network resources, and performs data delivery between the UE and a data network based on the controlled setup of the resources.

9. The method of claim 1, wherein the network service includes at least one of initial registration of the UE, deregistration of the UE, delivery of data from the UE, delivery of data to the UE, PDU session establishment, and mobility control of the UE.

10. The method of claim 9, wherein the mobility control of the UE includes a handover between the united network anchor function and at least one other united network anchor function.

11. The method of claim 9, wherein the initial registration of the UE includes establishing a signaling-only PDU session between the UE and the united network anchor function.

12. The method of claim 11, wherein a control message according to the established signaling-only PDU session is exchanged on an event basis between at least some of the UE, the network function, and the at least one other network function.

13. A network device included in a mobile communication system, the network device comprising:
a united control plane processing unit for controlling the setup of resources for a User Equipment (UE), including radio resources and core network resources; and
a united user plane processing unit for performing data delivery between the UE and a data network based on the controlled setup of the resources.

14. The network device of claim 13, wherein the network device is connected to a distributed unit of a radio access network via an F1 interface and to at least one network function included in a core network via a Service Based Interface (SBI).

15. The network device of claim 13, wherein the network device comprises a module that controls the maintenance of UE mobility and session connectivity with at least one second network device included in the mobile communication system, wherein the second network device comprises the united control plane processing unit and the united user plane processing unit.

16. The network device of claim 13, wherein the network device comprises a module that provides connection establishment and topology sharing with a united user plane processing unit included in at least one second network device, and provides an interface for connection with the at least one second network device.

17. The network device of claim 13, wherein the united control plane processing unit is connected to a distributed unit of a radio access network via an F1-c interface and processes a control plane of a central unit corresponding to the distributed unit.

18. The network device of claim 13, wherein the united user plane processing unit is connected to a distributed unit of a radio access network via an F1-u interface and performs a user plane function of the core network.

19. The network device of claim 13, wherein the united user plane processing unit manages policies including radio section policies and transport network policies, and performs SDAP processing and data delivery based on the managed policies.

20. The network device of claim 19, wherein the united user plane processing unit maps a radio section policy with a transport network policy, and performs user packet flow-level policy control through a PCF.
